(19) United States
(12) Patent Application Publication
(10) Pub. No.: US 2008/0300897 A1
(43) Pub. Date: Dec. 4, 2008

(54) Business method for domain name creation and marketing

(75) Inventors: Marina Gazetova, Visaginas (LT); Liudmila Gazetova, Visaginas (LT); Rafael Gazetov, Visaginas (LT)

Correspondence Address: YOUNG & THOMPSON, 209 Madison Street, Suite 500, ALEXANDRIA, VA, 22314, US

(73) Assignee: RAFAEL GAZETOV, VISAGINAS (LT)

(21) Appl. No.: 11/806,555

(22) Filed: Jun. 1, 2007

(51) Int. Cl. G06Q 30/00

(52) U.S. Cl. 705/1

(57) ABSTRACT

A business method for domain name creation and marketing uses multiple sales of definite rights for domain names and/or e-mail addresses from sellers to purchasers, either of which can be a person or a legal entity, with simultaneous creation of multiple independent compound domain names and e-mail addresses between them, and purchasers become compound domain name and e-mail address owners. Compound domain names and e-mail addresses contain permanent and variable parts. Permanent part is arranged in one, e.g., the right part and contains names, surnames, company names or other internet attributes of sellers. Variable part is arranged in the other, e.g., left part and contains names, surnames, company names or other internet attributes of purchasers. Permanent and variable parts are divided, e.g., by hyphen or dot. Compound domain name and e-mail address owners form networks, providing mass sales and marketing of products, services or advertisement.

### FIELD OF THE INVENTION

The present invention relates to Internet based business methods and domain names creation and registration methods. The present invention reveals trends relevant to new Internet based opportunities for persons or legal entities for example, from celebrities to their worshippers, from brand owners to their consumers, from branch (field, etc) owner to their consumers, worshippers, clients, end-users and etc. The present invention can be widely used in different fields and human activities spheres, in all community groups, for example internet users, business, science, sport, art, culture, music and other spheres, where multiple sales of definite rights for domain names and/or e-mail addresses use from sellers to purchasers and creation of independent compound domain names and/or e-mail addresses between sellers and purchasers, persons or legal entities, can take place from persons to persons, from legal entities to persons, from persons to legal entities, from legal entities to legal entities.

### BACKGROUND

In traditional creation, registration and marketing schemes of domain names, owners of domain names are facing a cyber squatting and type squatting effects. Especially, cyber squatting effect is causing many problems to celebrities, famous brands and other key and perspective domain names owners, their commercial and un-commercial activity, doing material and moral damage.

### SUMMARY OF THE INVENTION

The present invention has been made to overcome the disadvantages as mentioned above, and therefore, has an object to provide domain name creation and marketing business method that allows any persons or legal entities, companies and their customers, celebrities and their worshippers, brand owners and their clients, consumers or worshippers, branch (field, sphere, etc) owners and their clients, consumers or worshippers to create new joint products and effective tools as independent compound domain names and/or e-mail addresses. The present invention provides new opportunities for different groups of community, in public and business sector including direct selling sector and other fields and spheres.

In the present invention, business method for domain name creation and marketing is performed by multiple sales of definite rights for domain names and/or e-mail addresses use from sellers to purchasers, namely: from persons to persons; from legal entities to persons; from persons to legal entities, from legal entities to legal entities, with simultaneous creation of multiple compound domain names and/or e-mail addresses between them, and purchasers become compound domain name and/or e-mail address owners. A definite fee is paid to sellers by purchasers for rights of domain names and/or e-mail addresses use.

In the present invention, business method for domain name creation and marketing is performed by multiple sales of definite rights for domain names and/or e-mail addresses use from sellers, persons or legal entities, to as many as possible purchasers, persons or legal entities, and creation of joint product and instrument in terms of compound domain names and/or e-mail addresses, and purchasers become compound domain name and/or e-mail address owners. These compound domain name, and/or e-mail address owners form networks which provide mass sales and marketing of any products, services or advertisement.

In the present invention, compound domain names and/or e-mail addresses contain permanent and variable parts.

In the present invention, compound domain names and/or e-mail addresses contain permanent and variable parts, wherein permanent part is arranged in the one part for example, in the right part and contains names, surnames or other internet attributes of sellers, persons or legal entities, and variable part is arranged in the other part for example, in the left part and contains names, surnames or other internet attributes of purchasers, persons or legal entities. Permanent and variable parts are divided between them, for example by hyphen or dot.

Present invention provides creation of compound domain names and/or e-mail addresses between celebrities and their worshippers and form network.

Present invention provides creation of compound domain names and/or e-mail addresses between famous brand (company names, trademarks, etc.) owners and their clients, consumers, end-users or worshippers and form network.

Present invention provides creation of compound domain names and/or e-mail addresses between branch (commercial activity types, names of commodities, services, economical branch, geographical branch etc.) owners and their clients, consumers, end-users or worshippers and form network.

Present invention provides mass sales and marketing of any products, services or advertisement on the market by these formed networks.

### BRIEF DESCRIPTION OF THE DRAWINGS

FIG. 1 is a comprehensive block diagram showing multiple sales and marketing process of definite rights for domain names and/or e-mail addresses use from sellers to purchasers and simultaneous creation of independent compound domain names and/or e-mail addresses. Compound domain name and/or e-mail address owners form networks with following mass sales and marketing any products, services or advertisement on market by these formed networks;

FIG. 2A, 2B are comprehensive schemes of multiple sales of definite rights for domain names and/or e-mail addresses use from sellers to purchasers and creation algorithm of compound domain names and/or e-mail addresses between sellers and purchasers, whereas purchasers become compound domain name, and/or e-mail address owners;

FIG. 3A, 3B are comprehensive schemes of multiple sales of definite rights for domain names and/or e-mail addresses use from celebrities to worshippers, showing (an example Patricia Kaas, celebrity) creation algorithm of compound domain names and/or e-mail addresses between celebrities and worshippers, whereas worshippers become compound domain name and/or e-mail address owners;

FIG. 4A, 4B are comprehensive schemes of multiple sales of definite rights for domain names and/or e-mail addresses use from famous brand to consumers, showing (an example Panasonic, famous brand) creation algorithm of compound domain names and/or e-mail addresses between famous brand and consumers, worshippers or clients, whereas consumers, worshippers or clients become compound domain name and/or e-mail address owners;

FIG. 5A, 5B are comprehensive schemes of multiple sales of definite rights for domain names and/or e-mail addresses use from branch (field, sphere, etc) to consumers, showing example (an example science as branch, field) of creation algorithm of compound domain names and/or e-mail addresses between branches (fields, etc), and consumers, worshippers or clients, whereas consumers, worshippers or clients become compound domain name, and/or e-mail address owners;

### DESCRIPTION OF PREFERRED EMBODIMENT

Next, with reference to the accompanying drawings, a business method for domain names creation and marketing according to an embodiment of the present invention will be described.

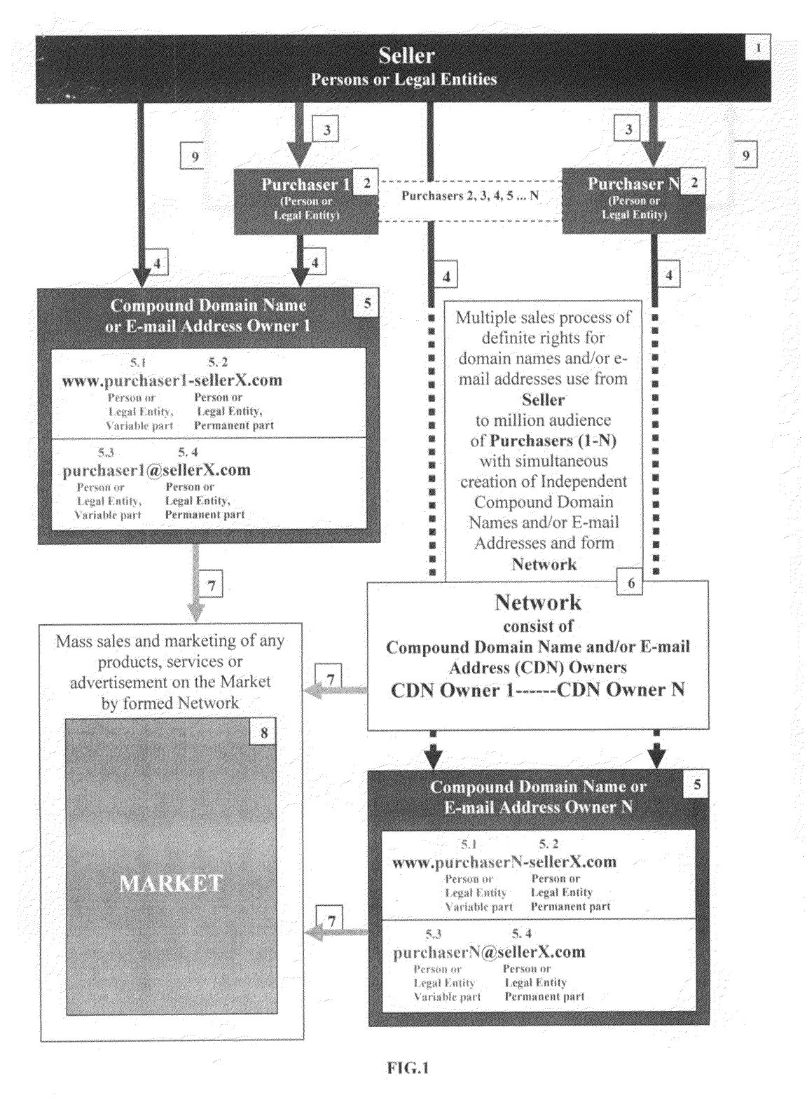

FIG. 1 is a comprehensive block-diagram showing the business process of creation and marketing compound domain names and/or e-mail addresses according to an embodiment of the present invention.

FIG. 1 shows and explains process of multiple sales and marketing of definite rights for domain names and/or e-mail addresses use from sellers 1 to purchasers 2 with simultaneous creation of domain names and/or e-mail addresses from sellers 1 (blue marked) to purchasers (1-N) 2 (red marked). Multiple sales process of definite rights for domain names and/or e-mail addresses use from sellers to purchasers shown by arrows 3 (red colour), and simultaneous creation process of independent compound domain names and/or e-mail addresses shown by arrows 4 (blue colour). Created compound product and instrument in terms of independent compound domain names and/or e-mail addresses 5 (red marked and white frame), which consist of permanent part 5.2 and 5.4 (blue marked) and variable part 5.1 and 5.3 (red marked). Permanent part 5.2 labelled blue colour, and variable part 5.1 labelled red colour and form compound domain name. Permanent part 5.4, labelled blue colour and variable part 5.3, labelled red colour, and form compound e-mail address.

FIG. 1 shows multiple mass sales and marketing process of definite rights for domain names and/or e-mail addresses use from sellers 1 to million audiences of purchasers (1-N) 2 with simultaneous creation of compound domain names (5.1 and 5.2) and/or e-mail addresses (5.3 and 5.4). Purchasers (1-N) 2 become new created compound domain name and/or e-mail address owners 5, which form network 6. By means of formed network is provided mass sales and marketing, shown by arrows 7, (green colour) any products, services or advertisement on the market 8, labelled green colour. A definite fee, as shown by arrows 9 (yellow colour), is paid to sellers by purchasers for rights of domain names and/or e-mail addresses use.

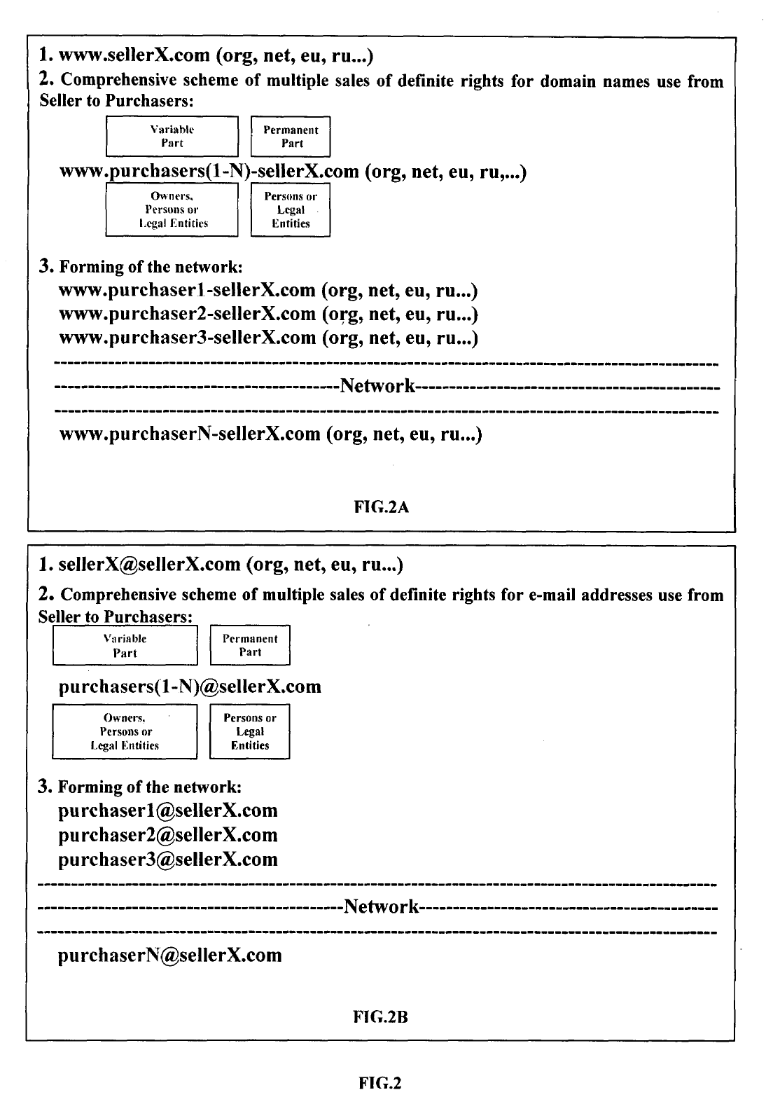

FIG. 2 shows comprehensive creation algorithm of compound domain names and/or e-mail addresses and forming network.

On FIG. 2A, clause 1, there is sellerX, person or legal entity, and corresponding domain name www.sellerX.com (org, net, eu, ru, etc).

FIG. 2A, clause 2, shows comprehensive scheme of multiple sales of definite rights for domain names use from sellerX to million audience of purchasers (1-N) with simultaneous creation of new independent compound domain names www.Purchasers(1-N)-sellerX.com (org, net, eu, ru, etc), whereas attributes of sellerX and purchasers (1-N) are divided by hyphen or dot. Purchasers (1-N), persons or legal entities, become compound domain name owners.

FIG. 2A, clause 3, shows forming process of sellerX network, which consist of multitude of compound domain name owners.

FIG. 2B shows comprehensive creation algorithm of compound e-mail addresses and forming network.

FIG. 2B, clause 1, there is sellerX, person or legal entity, and corresponding e-mail address sellerX@sellerX.com (org, net, eu, ru, etc).

FIG. 2B, clause 2, shows comprehensive scheme of multiple sales of definite rights for e-mail addresses use from sellerX to million audience of purchasers (1-N) with simultaneous creation of new independent compound e-mail addresses purchaser(1-N)@sellerX.com (org, net, eu, ru, etc), whereas attributes of sellerX and purchasers (1-N) are divided by hyphen or dot. Purchasers (1-N), persons or legal entities, become compound e-mail address owners.

FIG. 2B, clause 3, shows forming process of sellerX network, which consist of multitude of compound e-mail address owners.

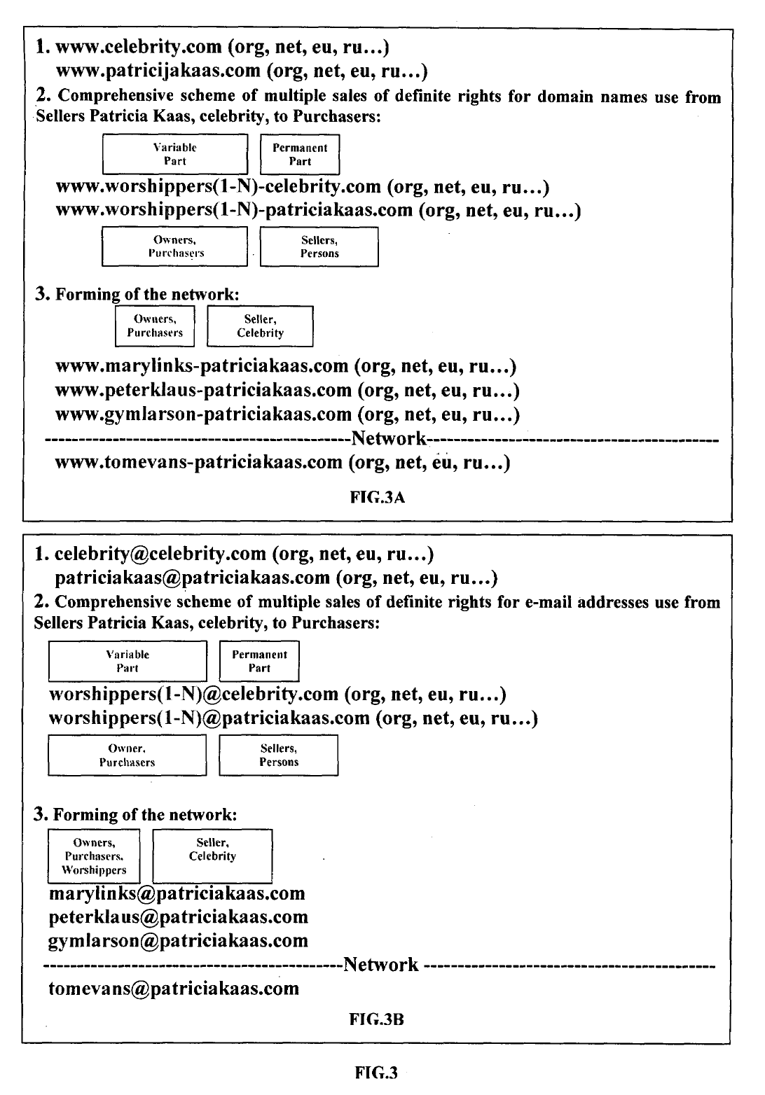

FIG. 3 shows comprehensive creation algorithm of independent compound domain names and/or e-mail addresses between celebrities and their worshippers and forming network.

On FIG. 3A clause 1, there is celebrity, and corresponding domain name www.celebrity.com (org, net, eu, ru, etc). For example, celebrity is Patricia Kaas and corresponding domain name www.patriciakaas.com (org, net, eu, ru, etc).

FIG. 3A clause 2, shows comprehensive scheme of multiple sales of definite rights for domain names use from celebrity to million audience of worshippers (1-N) with simultaneous creation of new independent compound domain names www.worshippers(1-N)-celebrity.com (org, net, eu, ru, etc). For example, celebrity, Patricia Kaas, multiple sales definite rights for domain names use to million audience of worshippers (1-N) with simultaneous creation of new independent compound domain names www.worshippers(1-N)-patriciakaas.com (org, net, eu, ru, etc), whereas attributes of Patricia Kaas and worshippers (1-N) are divided by hyphen or dot. Worshippers (1-N), persons or legal entities, become compound domain name owners.

FIG. 3A, clause 3, shows forming process of Patricia Kaas network, which consist of multitude of compound domain name owners, for example Mary Links, Peter Klaus, Gym Larson, etc.

On FIG. 3B clause 1, there is celebrity, and corresponding e-mail address celebrity@celebrity.com (org, net, eu, ru, etc). For example, celebrity is Patricia Kaas and corresponding e-mail address patriciakaas@patriciakaas.com (org, net, eu, ru, etc).

FIG. 3B clause 2, shows comprehensive scheme of multiple sales, whereas celebrity multiple sales definite rights for e-mail addresses use to million audience of worshippers (1-N) with simultaneous creation of new independent compound e-mail addresses worshippers(1-N)@celebrity.com (org, net, eu, ru, etc). For example, Patricia Kaas multiple sales definite rights for e-mail addresses use to million audience of worshippers (1-N) with simultaneous creation of new independent compound e-mail addresses worshippers(1-N)@patriciakaas.com (org, net, eu, ru, etc), whereas attributes of Patricia Kaas and worshippers (1-N) are divided by hyphen or dot. Worshippers (1-N), persons or legal entities, become compound e-mail address owners.

FIG. 3B, clause 3, shows forming process of Patricia Kaas network, which consist of multitude of compound e-mail address owners, for example Mary Links, Peter Klaus, Gym Larson, etc.

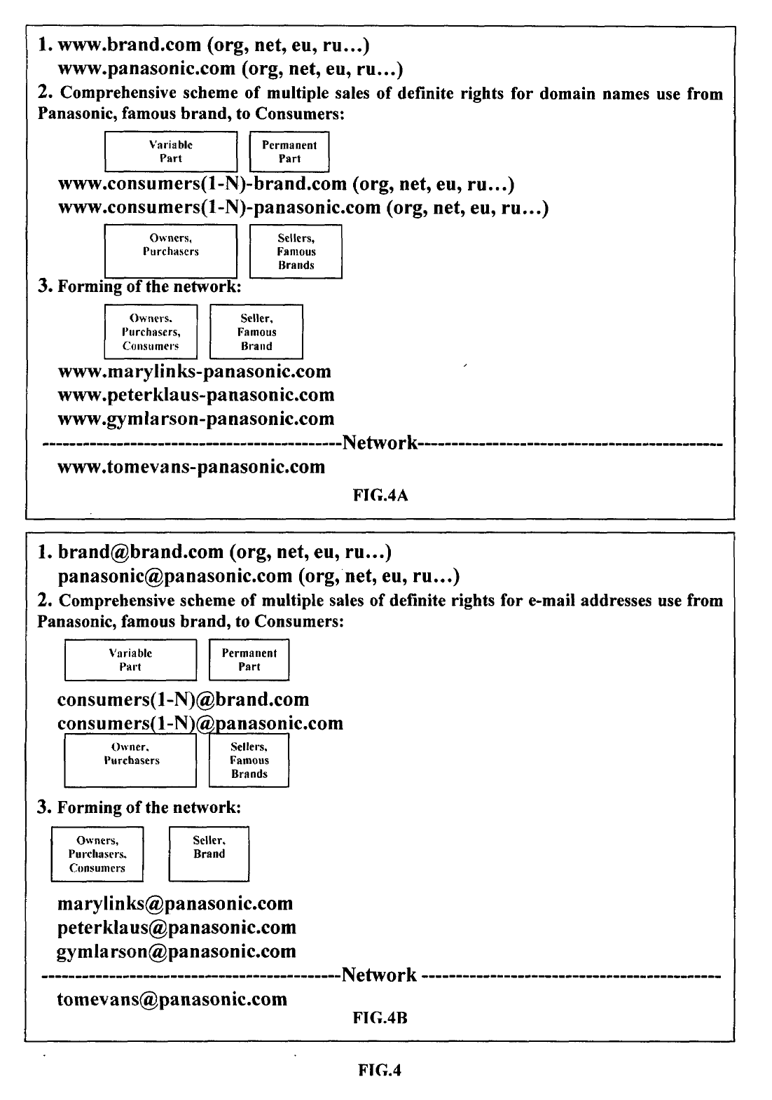

FIG. 4 shows comprehensive creation algorithm of independent compound domain names and/or e-mail addresses between famous brand and their consumers, clients or worshippers and forming network.

On FIG. 4A clause 1, there is famous brand, and corresponding domain name www.brand.com (org, net, eu, ru, etc). For example, famous brand is Panasonic and corresponding domain name www.panasonic.com (org, net, eu, ru, etc).

FIG. 4A clause 2, shows comprehensive scheme of multiple sales of definite rights for domain names use from famous brand to million audience of consumers (1-N) with simultaneous creation of new independent compound domain names www.consumers(1-N)-brand.com (org, net, eu, ru, etc). For example, famous brand, Panasonic multiple sales definite rights for domain names use to million audience of consumers (1-N) with simultaneous creation of new independent compound domain names www.consumers(1-N)-brand.com (org, net, eu, ru, etc), whereas attributes of Panasonic and consumers (1-N) are divided by hyphen or dot. Consumers (1-N), persons or legal entities, become compound domain name owners.

FIG. 4A, clause 3, shows forming process of Panasonic network, which consist of multitude of compound domain name owners, for example Mary Links, Peter Klaus, Gym Larson, etc.

On FIG. 4B clause 1, there is famous brand, and corresponding e-mail address brand@brand.com (org, net, eu, ru, etc). For example, famous brand is Panasonic and corresponding e-mail address panasonic@panasonic.com (org, net, eu, ru, etc).

FIG. 4B clause 2, shows comprehensive scheme of multiple sales of definite rights for e-mail addresses use from famous brand to million audience of consumers (1-N) with simultaneous creation of new independent compound e-mail addresses consumers(1-N)@brand.com (org, net, eu, ru, etc). For example, Panasonic multiple sales definite rights for e-mail addresses use to million audience of consumers (1-N) with simultaneous creation of new independent compound e-mail addresses consumers(1-N)@panasonic.com (org, net, eu, ru, etc), whereas attributes of Panasonic and consumers (1-N) are divided by hyphen or dot. Consumers (1-N), persons or legal entities, become compound e-mail address owners.

FIG. 4B, clause 3, shows forming process of Panasonic network, which consist of multitude of compound e-mail address owners, for example Mary Links, Peter Klaus, Gym Larson, etc.

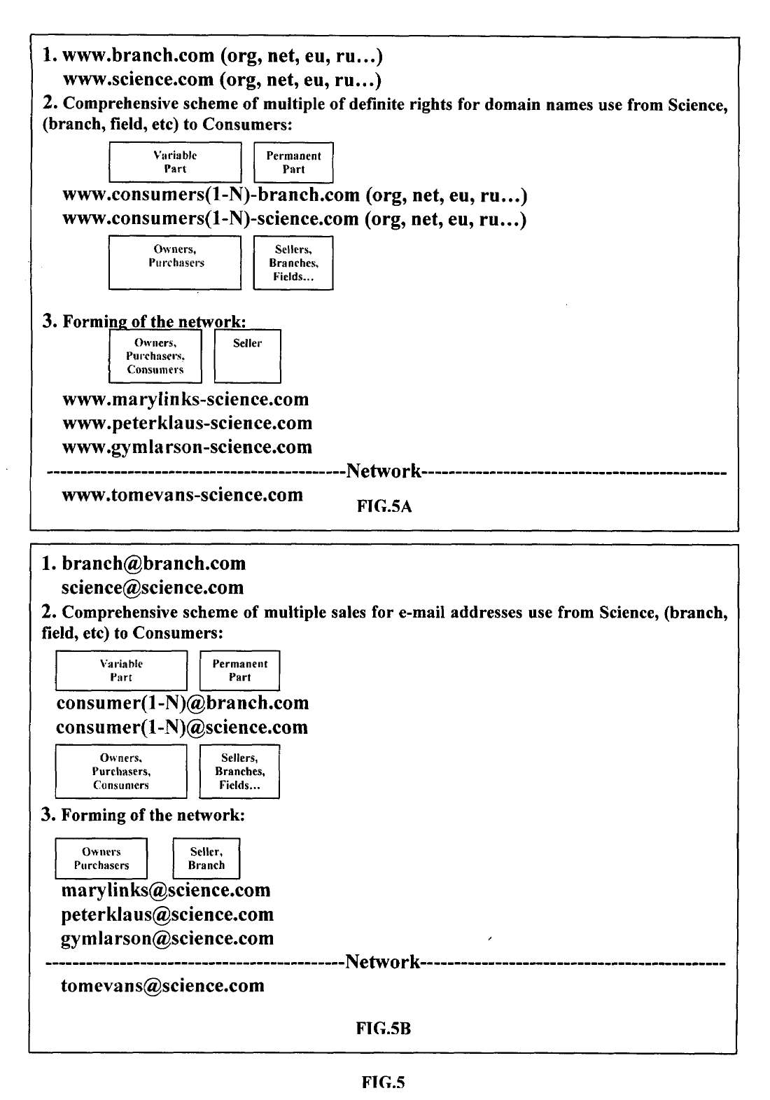

FIG. 5 shows comprehensive creation algorithm of compound domain names and/or e-mail addresses between branch, field and their consumers, clients or worshippers and forming network.

On FIG. 5A clause 1, there is brand, field and corresponding domain name www.branch.com (org, net, eu, ru, etc). For example, branch is Science and corresponding domain name www.science.com (org, net, eu, ru, etc).

FIG. 5A clause 2, shows comprehensive scheme of multiple sales of definite rights for domain names use branch (field, etc) to million audience of consumers (1-N) with simultaneous creation of new independent compound domain names www.consumers(1-N)-branch.com (org, net, eu, ru, etc). For example, branch, Science, multiple sales definite rights for domain names use to million audience of consumers (1-N) with simultaneous creation of new independent compound domain names www.consumers(1-N)-science.com (org, net, eu, ru, etc), whereas attributes of Science and consumers (1-N) are divided by hyphen or dot. Consumers (1-N), persons or legal entities, become compound domain name owners.

FIG. 5A, clause 3, shows forming process of Science network, which consist of multitude of compound domain name owners, for example Mary Links, Peter Klaus, Gym Larson, etc.

On FIG. 5B clause 1, there is branch, field. and corresponding e-mail address branch@branch.com (org, net, eu, ru, etc). For example, branch is Science and corresponding e-mail address science@science.com (org, net, eu, ru, etc).

FIG. 5B clause 2, shows comprehensive scheme of multiple sales of definite rights for e-mail addresses use branch (field, etc) to million audience of consumers (1-N) with simultaneous creation of new independent compound e-mail address consumers(1-N)@branch.com (org, net, eu, ru, etc). For example, Science multiple sales definite rights for e-mail addresses use to million audience of consumers (1-N) with simultaneous creation of new independent compound e-mail addresses consumers(1-N)@science.com (org, net, eu, ru, etc), whereas attributes of Science and consumers (1-N) are divided by hyphen or dot. Consumers (1-N), persons or legal entities, become compound e-mail address owners.

FIG. 5B, clause 3, shows forming process of Science network, which consist of multitude of compound e-mail address owners, for example Mary Links, Peter Klaus, Gym Larson, etc.

1-2. (canceled)

3. A business method for domain name creation and marketing is performed by multiple sales of definite rights for domain names and/or e-mail addresses use from sellers to purchasers, namely: from persons to persons; from legal entities to persons; from persons to legal entities, from legal entities to legal entities, with simultaneous creation of compound domain names and e-mail addresses between them, and purchasers become compound domain name and e-mail address owners. Compound domain names and e-mail addresses contain permanent and variable parts. Business method for domain name creation and marketing is performed by multiple sales of definite rights for domain names and/or e-mail addresses use from sellers, persons or legal entities, to as many as possible purchasers, persons or legal entities, with simultaneous creation of joint product and instrument in terms of compound domain names and/or e-mail addresses, and purchasers become compound domain name and/or e-mail address owners. These compound domain name and/or e-mail address owners form networks which provide marketing of any products, services or advertisement.

4. A business method for domain name creation and marketing according to claim 1, wherein compound domain names and/or e-mail addresses contain permanent and variable parts, wherein permanent part is arranged in the one part for example, in the right part and contains names, surnames and/or other internet attributes of sellers, persons or legal entities, and variable part is arranged in the other part for example, in the left part and contains names, surnames and/or other internet attributes of purchasers, persons or legal entities. Permanent and variable parts are divided between them on example, by hyphen or dot.
